(19) United States
(12) Patent Application Publication
(10) Pub. No.: US 2007/0169353 A1
(43) Pub. Date: Jul. 26, 2007

(54) Method and apparatus for a quick blade release folding utility knife

(76) Inventor: Harry Ching Lim Wu, Shatin (HK)

Correspondence Address: LETHAM PATENT GROUP LLC, 914 N. TUCANA LANE, GILBERT, AZ, 85234, US

(21) Appl. No.: 11/413,849

(22) Filed: Apr. 28, 2006

Related U.S. Application Data
(60) Provisional application No. 60/766,528, filed on Jan. 25, 2006.

(51) Int. Cl. B26B 3/06

(52) U.S. Cl. 30/155

(57) ABSTRACT

A utility knife comprising a handle, a blade holder, a slot penetrating the blade holder that is adapted to accept a blade, a recess inside the blade holder that is open to the slot, a button bore between one side of the blade holder and the slot, and a locking mechanism that has a button and a projection. The locking mechanism is configured to move between a locked position in which the projection engages and secures the blade and an unlocked position in which the locking mechanism enters the recess thereby withdrawing the projection from the slot and allowing a blade to be slidably removed from or inserted into the slot. The button on the locking mechanism is accessible through the button bore. Depressing the button moves the locking mechanism from a locked to an unlocked position thereby allowing the blade to slidably move in the slot.

### CROSS-REFERENCE TO RELATED APPLICATIONS

This application claims priority to, and the benefit of, U.S. provisional application Ser. No. 60/766,528 filed on Jan. 25, 2006 which is hereby incorporated by reference in its entirety.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to knives and in particular to folding utility knives adapted to use replacement blades.

2. Description of Related Art

Knives find uses in a variety of applications such as, for example, construction, hunting, food preparation, fishing, and woodcrafts. Knives may substantially benefit from a locking mechanism that facilitates changing replaceable blades.

### BRIEF SUMMARY OF THE INVENTION

Methods and apparatus according to various exemplary embodiments of the present invention comprise a handle, a blade holder, a slot penetrating the blade holder that is adapted to accept a blade, a recess inside the blade holder that is open to the slot, a button bore between one side of the blade holder and the slot, and a locking mechanism that has a button and a projection. The locking mechanism is configured to move between a locked position in which the projection engages and secures the blade and an unlocked position in which the locking mechanism enters the recess thereby withdrawing the projection from the slot and allowing the blade to be slidably removed from and/or inserted into the slot. The button on the locking mechanism is accessible through the button bore. Pressing the button moves the locking mechanism from a locked to an unlocked position thereby allowing the blade to slidably move in the slot.

### BRIEF DESCRIPTION OF THE DRAWINGS

A more complete understanding of the present invention may be derived by referring to the detailed description and claims when considered in connection with the figures, wherein like reference numbers refer to similar elements throughout the figures, and:

FIG. 1 is a diagram of a side view of an exemplary utility knife in an extended position in accordance with one embodiment of the present invention;

FIG. 2 is a diagram of a side view of an exemplary utility knife in a folded position in accordance with one embodiment of the present invention;

FIG. 3 is a diagram of a side cross-section view of an exemplary utility knife in an extended position in accordance with one embodiment of the present invention;

FIG. 4 is a diagram of a top view of an exemplary locking mechanism for a blade having anchor openings in accordance with one embodiment of the present invention;

FIG. 5 is a diagram of a perspective view of an exemplary locking mechanism having two projections in accordance with one embodiment of the present invention;

FIG. 6 is a diagram of a cross-section view of an exemplary locking mechanism in accordance with one embodiment of the present invention;

FIG. 7 is a diagram of a side cross-section view of an exemplary blade holder in accordance with one embodiment of the present invention;

FIG. 8 is a diagram of top view of an exemplary locking mechanism having one projection in accordance with one embodiment of the present invention;

FIG. 9 is a diagram of a top view of an exemplary locking mechanism having six projections in accordance with one embodiment of the present invention;

FIG. 10 is a diagram of a cross section view, taken along the line 10-10 of FIG. 1, of an exemplary locking mechanism in a locked position in accordance with one embodiment of the present invention;

FIG. 11 is a diagram of a cross section view, taken along the line 10-10 of FIG. 1, of an exemplary locking mechanism in an unlocked position in accordance with one embodiment of the present invention;

FIG. 12 is a diagram of a perspective view of an exemplary blade holder assembly in accordance with one embodiment of the present invention;

FIG. 13 is a diagram of a top view of an exemplary locking mechanism for a blade having anchor openings in accordance with one embodiment of the present invention;

FIG. 14 is a diagram of a top view of an exemplary locking mechanism in a locked position for a blade having anchor openings in accordance with one embodiment of the present invention.

### DETAILED DESCRIPTION OF EXEMPLARY EMBODIMENTS

The accompanying drawings show exemplary embodiments by way of illustration and best mode. While these exemplary embodiments are described, other embodiments may be realized and changes may be made without departing from the spirit and scope of the invention. Thus, the detailed description is presented for purposes of illustration only and not of limitation. For example, the steps recited in any of the method or process descriptions may be executed in any suitable order and are not limited to the order presented.

For the sake of brevity, conventional mechanical techniques, manufacturing methods, mechanical connections, techniques for urging movement, techniques for facilitating mechanical movement and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system. The present invention may be embodied as a customization of an existing system, an add-on product, or a distributed system.

The present invention is described partly in terms of functional components and various methods. Such functional components may be realized by any number of components configured to perform the specified functions and achieve the various results. In addition, the present invention may be practiced in conjunction with any number of applications and environments, and the systems described are merely exemplary applications of the invention. Further, the present invention may employ any number of conventional techniques for manufacture, testing, assembly, and the like.

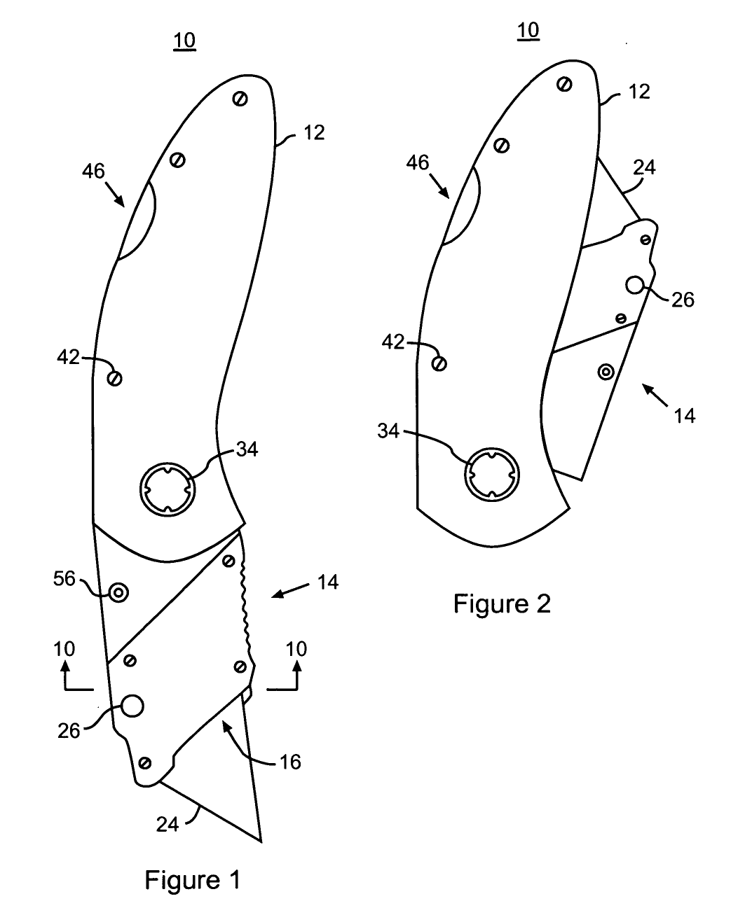

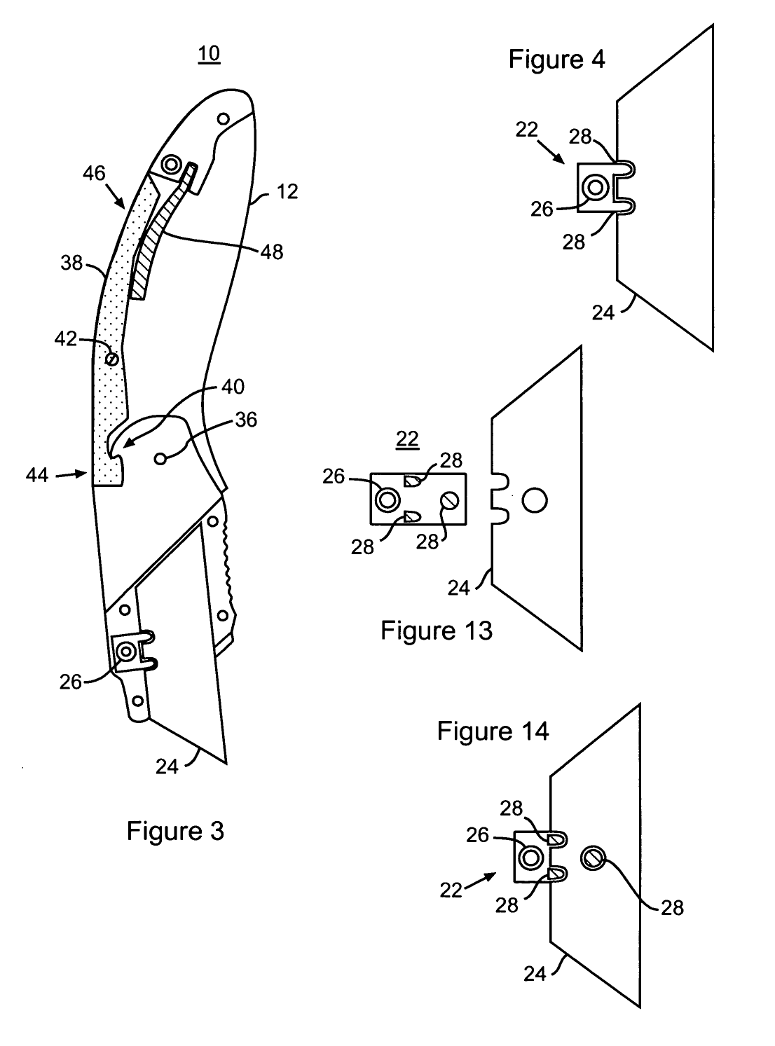

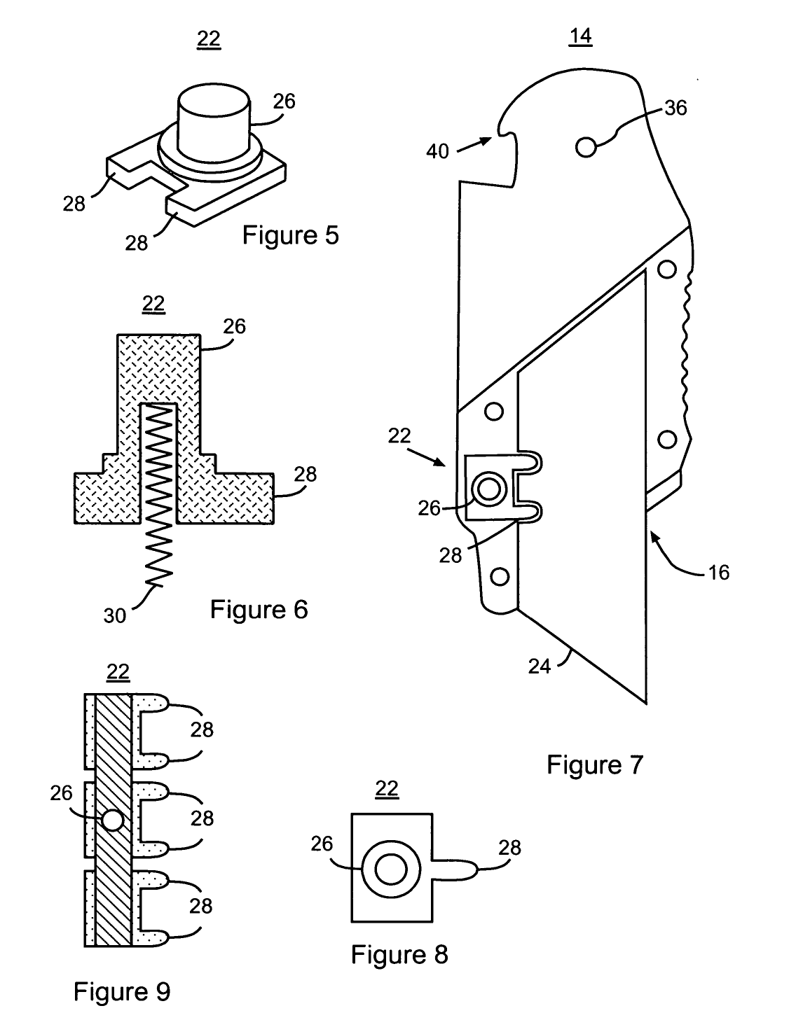

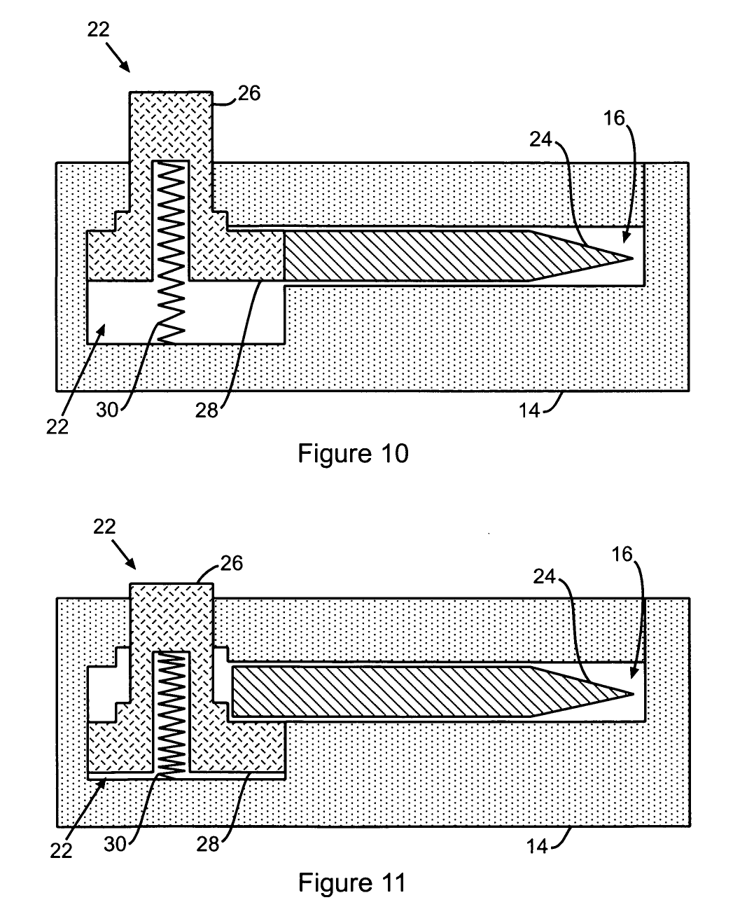

Methods and apparatus according to various exemplary embodiments of the present invention, utility knife 10, referring to FIGS. 1, 5, 7 and 12, comprise a handle 12, a blade holder 14, a slot 16, a recess 18, a button bore 20, and a locking mechanism 22. In an exemplary embodiment, utility knife 10 is configured to secure disposable blade 24 and to facilitate rapid replacement of blade 24 without the use of tools and/or the need to disassemble any part of knife 10. In an exemplary embodiment referring to FIGS. 1, 7 and 12, slot 16 is configured to slidably accept blade 24. Locking mechanism 22 is configured to secure blade 24 in slot 16 and to facilitate the removal of blade 24. In particular, locking mechanism 22 is biased in a locked position and is moveable to an unlocked position. In the locked position, locking mechanism 22 enters slot 16, engages blade 24, and secures blade 24 in slot 16. In an unlocked position, locking mechanism 22 disengages blade 24, exits slot 16, and enters recess 18, thereby enabling blade 24 to slidably enter and exit slot 16. In an exemplary embodiment, referring to FIGS. 1, 5-9, and 12, locking mechanism 22 has a button 26, at least one projection 28 configured to secure blade 24, and is adapted to at least partial enter recess 18. Locking mechanism 22 may be biased in the locked position in any manner. In one embodiment, referring to FIGS. 10-11, spring 30 biases locking mechanism in the locked position. In the locked position, referring to FIG. 10, locking mechanism 22 substantially exits recess 18 whereby projection 28 enters slot 16 and engages anchor opening 32 of blade 24. Positioning projection 28 in anchor opening 32 impedes slidable movement of blade 24 in slot 16 thereby securing blade 24 in slot 16. Pressing button 26 moves locking mechanism 22 from the locked to the unlocked position. In the unlocked position, referring to FIG. 9, locking mechanism 22 substantially enters recess 18 disengaging projection 28 from anchor opening 32 of blade 24, exiting slot 16 and, enabling slidable movement of blade 24 into and/or out of slot 16. Additional embodiments and aspects of utility knife 10 are disclosed herein.

Regarding handle 12, handle 12 may be of any shape and size, for example, handle 12 may be shaped to ergonomically fit into the human hand, attach to a machine, and facilitate convenient storage. In an exemplary embodiment, referring to FIG. 1, handle 12 is shaped and sized to ergonomically fit into the human hand. Handle 12 may be made of any material, for example, aluminum, stainless steel, spring steel, high-impact plastic, rubber, titanium, and any combination thereof. Handle 12 may have any mechanical configuration and may interface with blade holder 14 in any manner. For example, handle 12 may bolt to blade holder 14 in a fixed position, blade holder 14 may be inserted into a groove in handle 12 and be held with a pin, handle 12 may be pivotally attached to blade holder 14, and blade holder 14 may be integrated into handle 12. In an exemplary embodiment, referring to FIGS. 1 and 2, handle 12 pivotally connects to blade holder 14. Blade holder 14 pivots between an extended position, referring to FIG. 1, and a folded position, referring to FIG. 2. When entering the folded position, blade holder 14 pivots with respect to handle 12 until blade holder 14 is substantially adjacent to handle 12. In an exemplary embodiment, in the folded position, blade holder 14 partially enters a groove in handle 12. In particular, handle 12 comprises two half sides and a spacer. The spacer is positioned between the half sides thereby leaving an open groove in body 12. In the folded position, blade holder 14 is partially disposed in the groove between the two sides. In the extended position, blade holder 14 extends from handle 12 at angle configured to facilitate use of blade 24 for cutting operations. In an exemplary embodiment, referring to FIG. 1, blade holder 14 extends from one end of handle 12 at a substantially linear angle.

A pivotal connection between handle 12 and blade holder 14 may be accomplished in any manner. In an exemplary embodiment, referring to FIGS. 1-3 and 7, pin 34 extends through handle 12 and pivot bore 36 of blade holder 14. In the extended position, latch portion 44 of locking arm 38 engages hook 40 of blade holder 14, thereby retaining blade holder 14 in the extended position. Locking arm 38 pivots around pin 42. Force member 48 applies force to locking arm 38 to urge locking arm 38 into a locked position. Latch portion 44 of locking arm 38 may be disengaged from hook 40 of blade holder 14 by pressing release portion 46 of locking arm 38. When latch portion 44 is disengaged from hook 40, blade holder 14 may pivot around pin 34 disposed in pivot bore 36 between the folded position and the extended position. Blade holder 14 may be moved between the extended position and the folded position in any manner. In an exemplary embodiment, blade holder 14 additionally comprises knob 56 to facilitate moving blade holder 14 from the folded position to the extended position using a single hand. Handle 12 may additionally comprise a clip (not shown) configured to secure handle 12 to clothing.

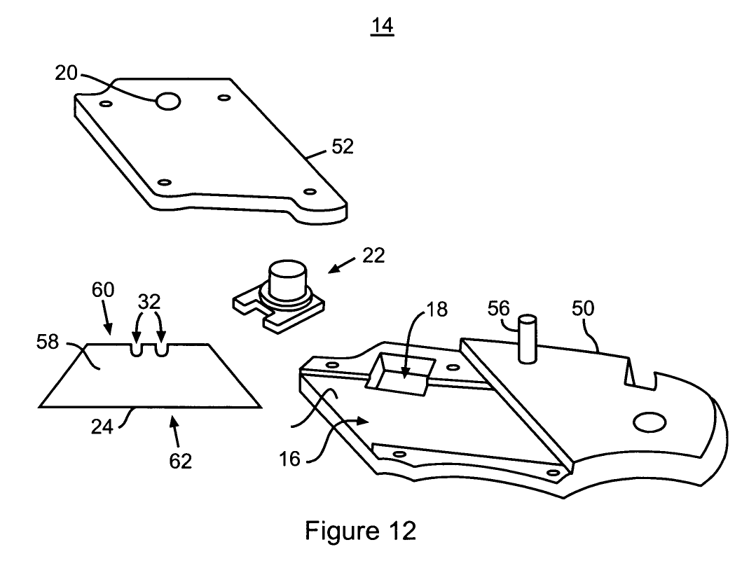

Regarding blade holder 14, blade holder 14 may be configured to accept and retain replacement blade 24 in any manner. In an exemplary embodiment, referring to FIG. 10-11 and 12, blade holder 14 has slot 16 configured for slidable insertion and removal of blade 24. Slot 16 is open at one end of blade holder 14 to facilitate the insertion and removal of blade 24. Slot 16 may be formed in any manner. In an exemplary embodiment, blade holder 14 comprises a base 50 and a lid 52. Base 50 has depressed surface 54. Placing lid 52 over depressed surface 54 forms slot 16 having depressed surface 54 as a first inner surface and the inside of lid 52 as a second inner surface. Lid 52 may be attached to base 50 in any manner. In an exemplary embodiment, lid 52 is fixedly attached to base 50 using threaded screws. The width of slot 16 corresponds to the depth of depressed surface 54 and is configured to facilitate the slidable insertion and removal of blade 24 of predetermined thickness. When inserted, blade 24 is disposed between the first inner surface and the second inner surface of slot 16. Blade 24 may be of any shape, size, and/or thickness. In an exemplary embodiment, blade 24 has a first side 58, a second side (not shown) substantially parallel to first side 58, a top edge 60, and a cutting edge 62. Blade 24 is thin, thus the distance between first side 50 and the second side (not shown) of blade 24 is relatively small. In another embodiment, blade holder 14 is solid and slot 16 is machined into the end of blade holder 14. Slot 16 may be of any shape. In an exemplary embodiment, referring to FIGS. 3, 7, and 12, slot 16 is substantially trapezoidal and is configured to accept blade 24 which has a substantially trapezoidal shape. Slot 16 may penetrate blade holder 14 to any depth. In an exemplary embodiment, the depth of slot 16 is sufficient to accommodate most of blade 24 leaving a portion of blade 24, cutting edge 62 in particular, extending from slot 16 and the end of blade holder 14. Blade holder 14 may be configured in any manner to facilitate access to locking mechanism 22. In an exemplary configuration, referring to FIGS. 1 and 12, button bore 20 facilitates access to locking mechanism 22. In particular, referring to FIGS. 4-6 and 10-11, locking mechanism comprises button 26 and projection 28. In an exemplary embodiment, button 26 is fixedly connected to projection 28. Button 26 is disposed in button bore 20 and is accessible from the exterior of blade holder 14. Pressing button 26 slidably moves button 26 in button bore 20. Button bore 20 may enter blade holder 14 from any location on blade holder 14 and at any angle. In an exemplary embodiment, button bore 20 passes through lid 52. Placement of lid 52 on base 50 configures button bore 20 to be open to the exterior of blade holder 14, to slot 16, and recess 18. Locking mechanism 22 may move in any direction relative to blade 24. In an exemplary embodiment, locking mechanism 22 moves substantially perpendicular to first side 58 and second side (not shown) of blade 24. In an exemplary embodiment, projection 28 and button 26 move substantially perpendicular to first side 58 and second side (not shown) of blade 24. The surface of the first inner surface and the second inner surface may have any contour. In an exemplary embodiment, the first inner surface and the second inner surface are substantially planar. In another embodiment, the first inner surface and the second inner surface have ridges.

Regarding locking mechanism 22, locking mechanism 22 may engage and disengage blade 24 in any manner. In an exemplary embodiment, referring to FIGS. 4, 7 and 10-11, locking mechanism is biased in a locked position and is moveable to an unlocked position. In the locked position, referring to FIGS. 4 and 10, projection 28 of locking mechanism 22 enters slot 16 and enters anchor opening 32 of blade 24. In the locked position, slight slidable movement of blade 24 in slot 16 brings projection 28 into contact with the edge of anchor opening 32, thereby halting slidable movement of blade 24 in slot 16, thereby securing blade 24 in slot 16. In the unlocked position, referring to FIG. 11, projection 28 exits anchor opening 32 and slot 16, thereby facilitating slidable insertion and removal of blade 24 into and out of slot 16. Projection 28 and/or locking mechanism 22 may exit slot 16 in any manner. In an exemplary embodiment, pressing button 26 of locking mechanism 22 moves projection 28 and/or locking mechanism 22 substantially from slot 16 and substantially into recess 18. Recess 18 may be any shape, size, and/or depth. In an exemplary embodiment, referring to FIGS. 10-11 and 12, the size and/or shape of recess 18 facilitates accepting a substantial portion of locking mechanism 22 in the unlocked position. In particular, projection 28 substantially enters recess 18, thereby substantially exiting slot 16 and anchor opening 32, thereby disengaging blade 24. Recess 18 may at any location in blade holder 14 and in any position relative to slot 16. In an exemplary embodiment, recess 18 is formed in base 50 and at least partially in depressed surface 54 and/or first inner surface. Locking mechanism 22 may be biased in the locked position in any manner. In an exemplary embodiment, spring 30 provides force between clocking mechanism 22 and the bottom of recess 18. In another embodiment, a first magnet is attached to locking mechanism 22 and a second magnet is positioned in the bottom of recess 18. The magnets are position such that the first magnet repels the second magnet, thereby providing force to bias locking mechanism 22 in the locked position.

Locking mechanism 22 may be configured to engage anchor openings of any size, shape, and/or orientation. In an exemplary embodiment, referring to FIG. 4, projection 28 of locking mechanism 22 is configured to enter and engage partially oval anchor opening 32 positioned along top edge 60 of blade 24. In another embodiment, referring to FIGS. 13-14, locking mechanism 22 is configured to enter and engage a substantially circular anchor opening positioned substantially in the center of blade 24. Locking mechanism 22 may have any number of projections 28. In an exemplary embodiment, referring to FIGS. 4-5, locking mechanism 22 comprises two projections adapted to enter and engage partially oval anchor openings 32 positioned on the edge of blade 24. In another embodiment, referring to FIGS. 13-14, locking mechanism 22 comprises three projections; two projections 28 configured to enter and engage partially oval anchor openings 32 positioned along top edge 60 of blade 24 and one projection 28 configured to enter and engage a substantially circular anchor opening positioned substantially in the center of blade 24. In another embodiment, referring to FIG. 8, locking mechanism 22 comprises one projection 28. In another embodiment, referring to FIG. 9, locking mechanism 22 comprises at least two pairs of projections wherein each projection pair is biased in the locked position independent of the other projection pairs, whereby those projections 28 that do not enter and engage an anchor opening 32 press against the side of blade 24 in the locked position, thereby providing additional force to secure blade 24 in slot 16.

Although the description above contains many details, these should not be construed as limiting the scope of the invention but as merely providing illustrations of some of the exemplary embodiments of this invention. The scope of the present invention fully encompasses other embodiments, and is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments are expressly incorporated by reference and are intended, unless otherwise specified, to be encompassed by the claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims. No claim element is to be construed under the provisions of 35 U.S.C. 112, sixth paragraph, unless the element is expressly recited using the phrase “means for.” The terms “comprises”, “comprising”, or any other variation, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A utility knife, comprising:
a handle having a groove;
a blade holder having a first end, a second end, a first side, a second side, said second end configured to pivotally attach to said handle; said blade holder pivotally moveable between an extended position and a folded position; wherein in said folded position said blade holder is at least partially disposed in said groove;
a slot partially penetrating said blade holder and open at said first end, said slot configured for slidable insertion and removal of a blade, said blade having an anchor opening, said slot having a first inner surface and a second inner surface, wherein said blade is slidably disposed between said first inner surface and said second inner surface;
a recess partially penetrating said first inner surface and open to said slot;
a button bore partially penetrating said blade holder, open between said second side of said blade holder and said second inner surface of said slot; and,
a locking mechanism having a button and a projection, said button fixedly connected to said projection, said locking mechanism biased in a locked position and moveable to an unlocked position, said button disposed in said button bore, said projection configured to engage said anchor opening, wherein pressing said button moves said locking mechanism from said locked position into said unlocked position, wherein as said locking mechanism moves from said locked position to said unlocked position said projection disengages from said anchor opening, exits said slot, and enters said recess, thereby permitting slidable insertion and removal of said blade; wherein as said locking mechanism moves from said unlocked position to said locked position said projection exits said recess, enters said slot, and engages said anchor opening thereby securing said blade against slidable movement in said slot.

2. The utility knife of claim 1, additionally comprising a spring, said spring partially disposed in said recess, wherein said spring biases said locking mechanism in said locked position.

3. The utility knife of claim 1, said blade holder additionally comprising a knob configured to facilitate pivotal movement of said blade holder from said folded position to said extended position.

4. The utility knife of claim 1, said blade holder additionally comprising a base having a depressed surface and a lid, said depressed surface forming said first inner surface and said lid forming said second inner surface, wherein said lid fixedly attaches to said base.

5. The utility knife of claim 1, wherein said first inner surface and said second inner surface are substantially planar.

6. The utility knife of claim 1, said handle additionally comprising a first half, a second half, a locking arm having a latch portion and a release portion, and a force member, said first half and said second half spaced to form said groove, said locking arm and said force member disposed between said first half and said second half, said force member biasing said locking arm in a locked position.

7. The utility knife of claim 6, wherein pressing said release portion moves said locking arm from said locked position to an unlocked position.

8. The utility knife of claim 7, said blade holder additionally comprising a hook adapted to engage said latch portion when said blade holder is in said extended position, said hook formed in said second end.

9. The utility knife of claim 8, wherein when said blade holder is in said extended position and said locking arm is in said locked position, said latch portion engages said hook, thereby securing said blade holder in said extended position.

10. The utility knife of claim 9, wherein when said locking arm is in said unlocked position, said latch portion disengages from said hook, thereby allowing said blade holder to pivot between said extended position and said folded position.

11. A utility knife, comprising:
a handle having a groove;
a blade holder having a first end, a second end, a first side, a second side, said second end configured to pivotally attach to said handle; said blade holder pivotally moveable between an extended position and a folded position; wherein in said folded position said blade holder is at least partially disposed in said groove;
a slot partially penetrating said blade holder and open at said first end, said slot configured for slidable insertion and removal of a blade, said blade having a first side, a second side, a top edge, a cutting edge, and an anchor opening disposed in said top edge and open to said first side and said second side of said blade, said slot having a first inner surface and a second inner surface, wherein said blade is slidably disposed between said first inner surface and said second inner surface, wherein said first side of said blade is adjacent to said first inner surface and said second side of said blade is adjacent to said second inner surface, wherein a portion of said cutting edge extends from said first end when said blade is fully inserted into said slot;
a recess partially penetrating said first inner surface and open to said slot;
a button bore partially penetrating said blade holder, open between said second side of said blade holder and said second inner surface of said slot; and,
a locking mechanism having a button and a projection, said button fixedly connected to said projection, said locking mechanism biased in a locked position and moveable to an unlocked position, said button disposed in said button bore, said projection configured to engage said anchor opening, wherein pressing said button moves said locking mechanism from said locked position into said unlocked position, wherein as said locking mechanism moves from said locked position to said unlocked position said projection moves substantially perpendicular to said first side of said blade, disengages from said anchor opening, exits said slot, and enters said recess, thereby permitting slidable insertion and removal of said blade; wherein as said locking mechanism moves from said unlocked position to said locked position said projection approaches said first side of said blade, exits said recess, enters said slot, and engages said anchor opening thereby securing said blade against slidable movement in said slot.

12. The utility knife of claim 11, additionally comprising a spring, said spring partially disposed in said recess, wherein said spring biases said locking mechanism in said locked position.

13. The utility knife of claim 11, said blade holder additionally comprising a knob configured to facilitate pivotal movement of said blade holder from said folded position to said extended position.

14. The utility knife of claim 11, said blade holder additionally comprising a base having a depressed surface and a lid, said depressed surface forming said first inner surface and said lid forming said second inner surface, wherein said lid fixedly attaches to said base.

15. The utility knife of claim 11, wherein said first inner surface and said second inner surface are substantially planar.

16. The utility knife of claim 11, said handle additionally comprising a first half, a second half, a locking arm having a latch portion and a release portion, and a force member, said first half and said second half spaced to form said groove, said locking arm and said force member disposed between said first half and said second half, said force member biasing said locking arm in a locked position.

17. The utility knife of claim 16, wherein pressing said release portion moves said locking arm from said locked position to an unlocked position.

18. The utility knife of claim 17, said blade holder additionally comprising a hook adapted to engage said latch portion when said blade holder is in said extended position, said hook formed in said second end.

19. The utility knife of claim 18, wherein when said blade holder is in said extended position and said locking arm is in said locked position, said latch portion engages said hook, thereby securing said blade holder in said extended position.

20. The utility knife of claim 19, wherein when said locking arm is in said unlocked position, said latch portion disengages from said hook, thereby allowing said blade holder to pivot between said extended position and said folded position.
